(19) United States
(12) Patent Application Publication
(10) Pub. No.: US 2014/0157521 A1
(43) Pub. Date: Jun. 12, 2014

(54) MULTI-PURPOSE TOOL

(71) Applicants: DENNIS J. TUOHY, III, Newton, NJ (US); Jeannie Tuohy, Newton, NJ (US)

(72) Inventors: DENNIS J. TUOHY, III, Newton, NJ (US); Jeannie Tuohy, Newton, NJ (US)

(21) Appl. No.: 13/849,232

(22) Filed: Mar. 22, 2013

Related U.S. Application Data
(60) Provisional application No. 61/797,650, filed on Dec. 12, 2012.

(51) Int. Cl. B25F 1/00

(52) U.S. Cl. CPC B25F 1/00
USPC 7/105

(57) ABSTRACT

A multipurpose tool is disclosed. The multipurpose tool comprises a flexible material comprising a proximate region formed as a scraper and a first semicircular hook, a distal region formed as a second semicircular hook, and a straight intermediate region therebetween having a jagged side edge or toothed portion. The first semicircular hook comprises an inner surface with a clip formed thereon.

### CROSS-REFERENCE TO RELATED APPLICATIONS

This application claims the benefit of pending U.S. Provisional Patent Applications Ser. No. 61/638, 928, filed Mar. 22, 2012, entitled “PAINTER'S MULTI-TOOL,” which application is incorporated herein by reference in its entirety and Ser. No. 61/797,650 filed Dec. 12, 2012, entitled “PAINTER'S MULTI-TOOL,” which application is incorporated herein by reference in its entirety.

### FIELD OF THE INVENTION

The present invention relates to a multipurpose apparatus and, more particularly to a multipurpose tool for aiding in multiple different activities associated with painting.

### BACKGROUND OF THE INVENTION

To paint a small or large area, a minimum amount of equipment is required. For example, a list of the items needed to perform the task would include a tool to open a can of paint, a paintbrush, a pail (touchup container), roller, roller tray, a rag, roll of tape, a scraper/putty knife, a brush comb, a brush repository and so on. While generally not very expensive, the various tools do require investment in terms of money, storage space and so on to keep track of necessary tools for subsequent jobs.

### SUMMARY OF THE INVENTION

Various deficiencies of the prior art are addressed by a multipurpose apparatus or tool adapted to support multiple different activities associated with painting. The multipurpose tool comprises a flexible material having a proximate region formed as a scraper and a first semicircular hook, a distal region formed as a second semicircular hook, and a straight intermediate region therebetween having a jagged side edge or toothed portion. The first semicircular hook comprises an inner surface with a clip formed thereon.

### BRIEF DESCRIPTION OF THE DRAWINGS

The teachings of the present invention can be readily understood by considering the following detailed description in conjunction with the accompanying drawings, in which:

FIG. 1 depicts an exemplary multipurpose tool according to one embodiment;

FIGS. 2A, 2B, 2C and 2D depict the scraper/putty knife of the exemplary multipurpose tool according to one embodiment;

FIGS. 3A and 3B graphically illustrate the multipurpose tool attached to a can opener according to one embodiment;

FIG. 4 graphically illustrates the magnet device of the multipurpose tool clamping to a paint brush according to one embodiment;

FIGS. 5A, 5B and 5C graphically illustrate the multipurpose tool being used as a handle for pint/quart size pails according to one embodiment;

FIG. 6 graphically illustrates the multipurpose tool being attached to a roller tray according to one embodiment;

FIG. 7 graphically illustrates the multipurpose tool being used to drape one or more rags according to one embodiment;

FIG. 8 graphically illustrates the multipurpose tool being used as a load bearing apparatus according to one embodiment;

FIG. 9 graphically illustrates the multipurpose tool being used as a load bearing apparatus according to another embodiment;

FIG. 10 graphically illustrates the multipurpose tool being used as a load bearing belt attachment according to one embodiment;

FIGS. 11A, 11B and 11C graphically illustrate the multipurpose tool being used to clean a paint brush according to one embodiment;

FIGS. 12A, 12B and 12C graphically illustrate the multipurpose tool being used to clean a roller according to one embodiment;

FIGS. 13A and 13B graphically illustrate the multipurpose tool being used as an organizer according to various embodiments; and

FIG. 14 depicts an exemplary embodiment of the multipurpose tool with a plurality of reinforcement spines and magnet cushions according to one embodiment; and

FIG. 15 depicts an exemplary embodiment of the multipurpose tool showing the length of the plurality of reinforcement spines according to one embodiment.

To facilitate understanding, identical reference numerals have been used, where possible, to designate identical elements that are common to the figures.

### DETAILED DESCRIPTION

The invention will be primarily described within the context of particular embodiments; however, those skilled in the art and informed by the teachings herein will realize that the invention is also applicable to other technical areas and/or embodiments. For example, since the various embodiments of an apparatus or tool are well adapted to painting related activities, the invention is also applicable to any type of activity in which a coating such as paint, varnish and the like is applied to a surface. Moreover, though the various embodiments are directed to an apparatus or tool well adapted to painting related activities, various features associated with the apparatus or tool may be successfully used within the context of non-painting related activities. Thus, those skilled in the art may readily devise many other varied embodiments that still incorporate these teachings.

Generally speaking, the present invention is a multi-purpose, multi-job tool or device that is small enough to fit in one's pocket. The multi-purpose tool is manufactured using, illustratively, a flexible plastic or metal material that will tend not to crack or break when exposed to temperature variations, mechanical stresses and the like as described herein. Various embodiments utilize ABS, polypropylene and the like. Although primarily described with respect to flexible plastic or metal, a semi-flexible plastic or metal, or any other material exhibiting characteristics consistent with the characteristics and applications discussed herein may also be used.

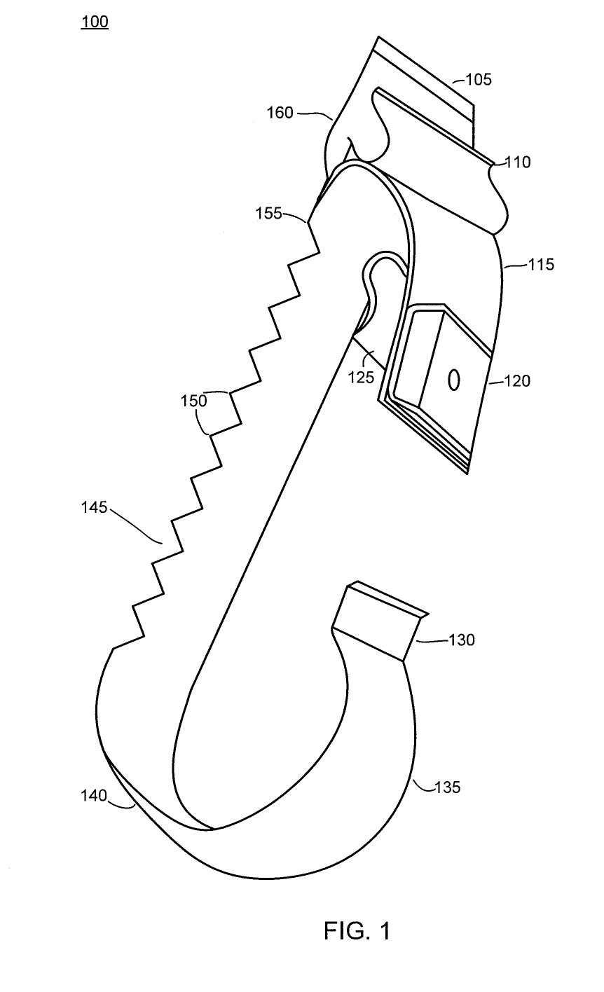

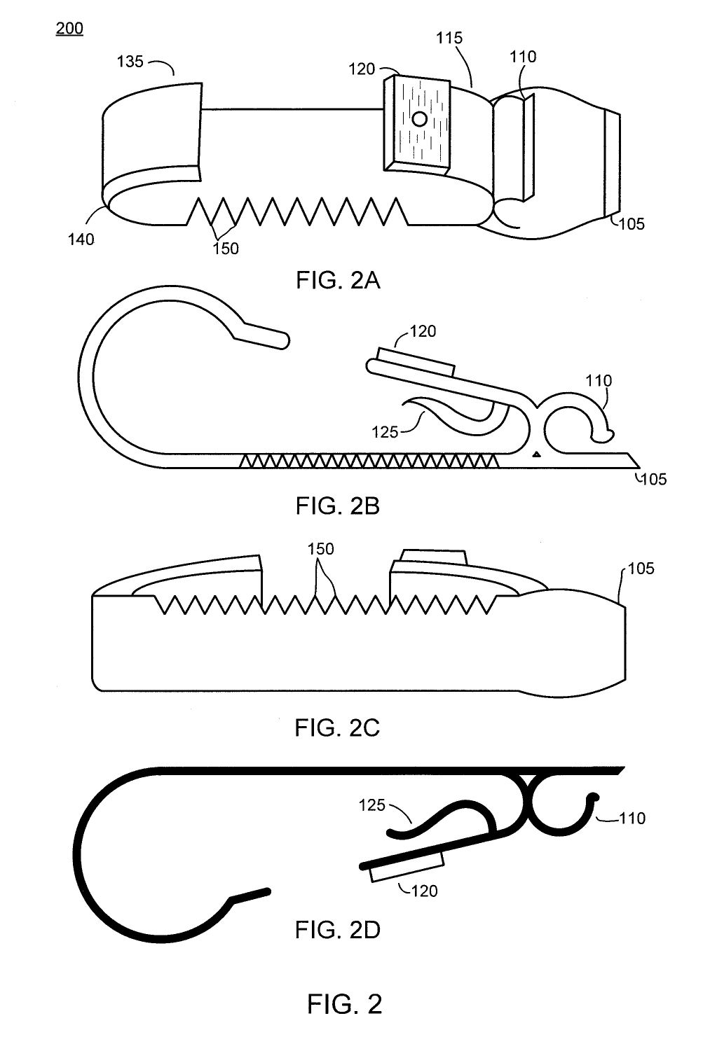

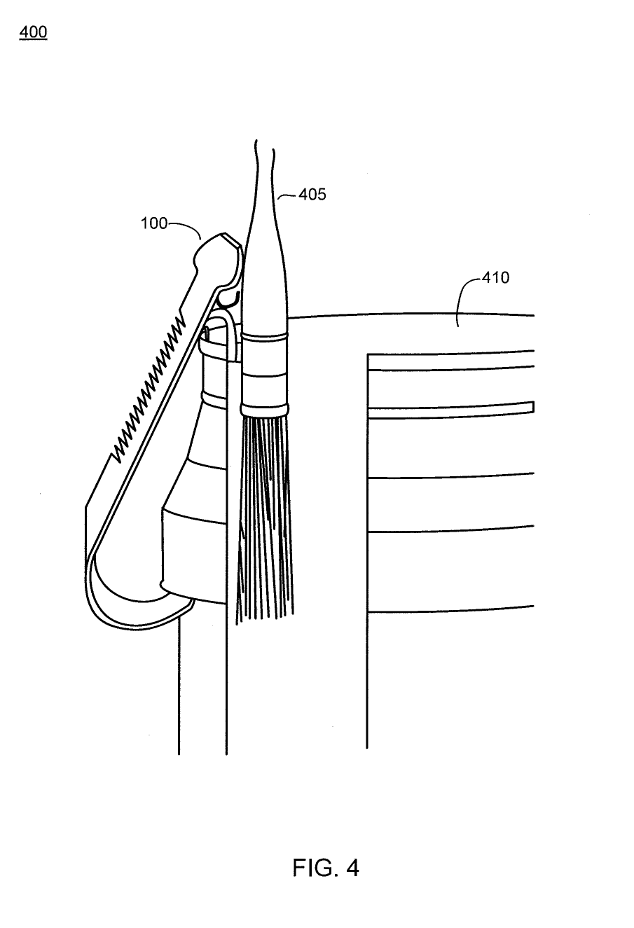

FIG. 1 depicts an exemplary multipurpose tool according to one embodiment. Specifically, multi-purpose tool or device 100 includes two or more of a scraper or putty knife 105 described in reference to FIGS. 2A-2D, a first semicircular hook 110, a roller tray clip 115, a magnetic assembly 120 described in reference to FIG. 4 and

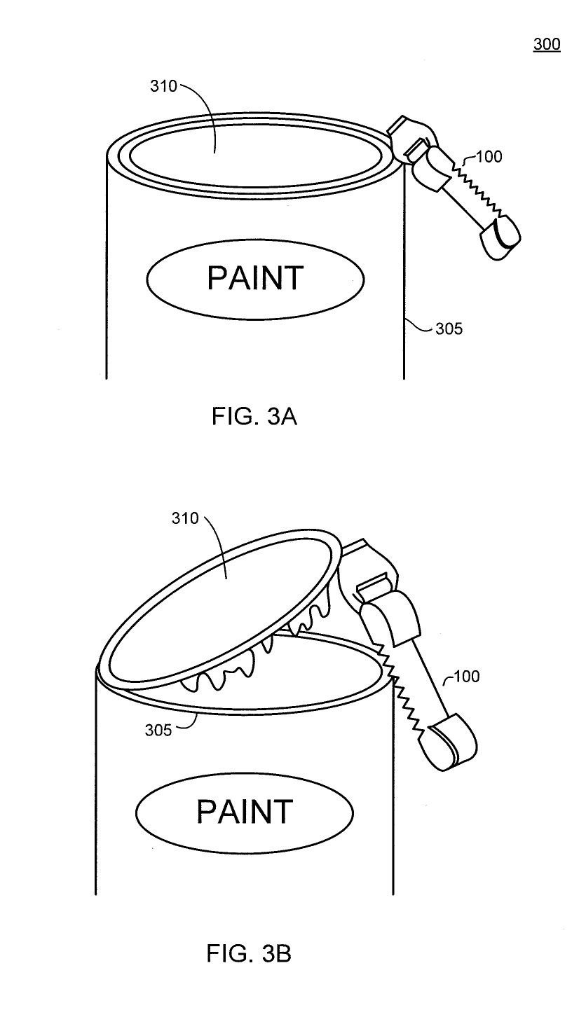

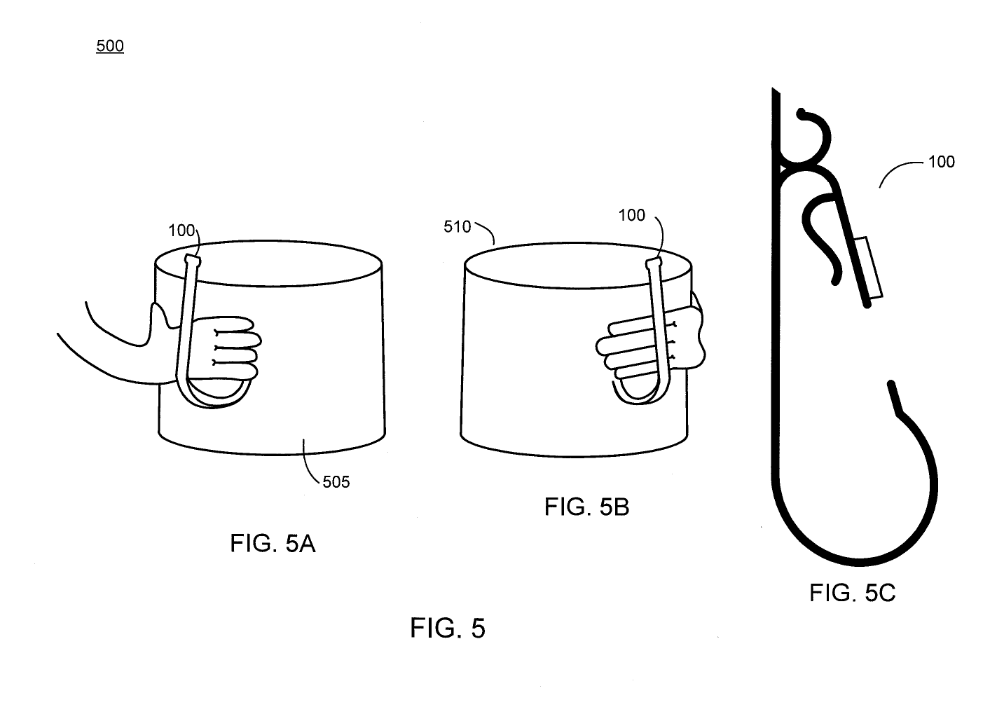

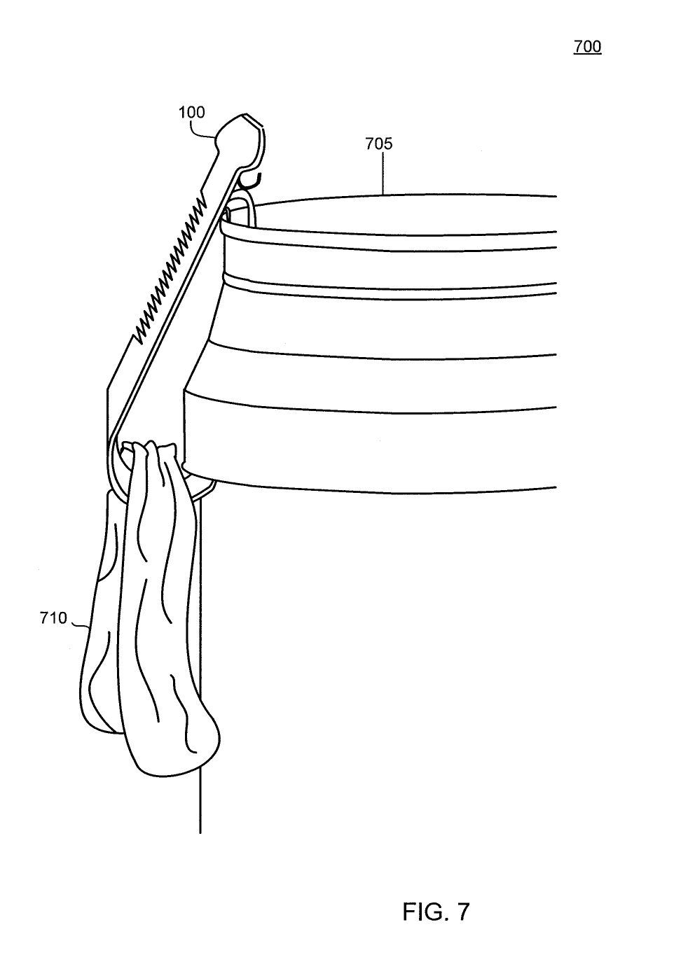

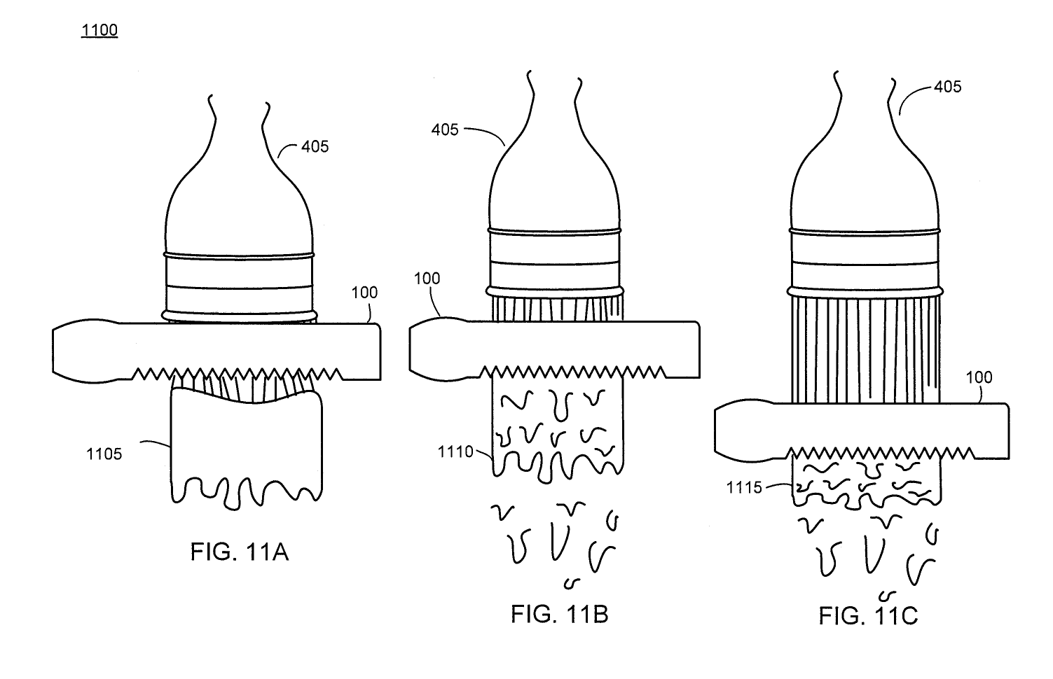

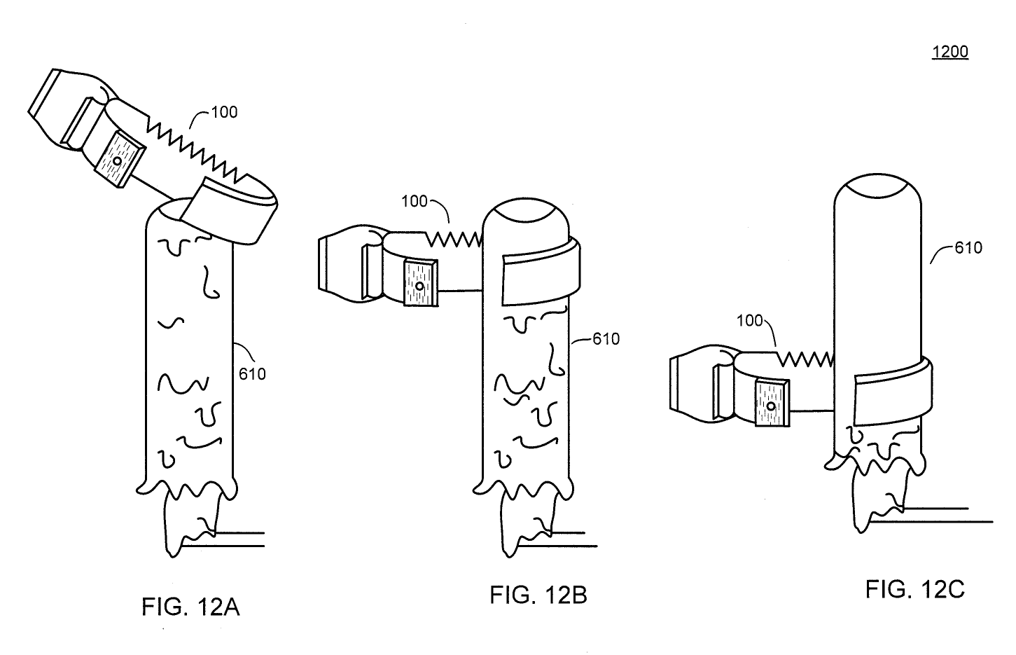

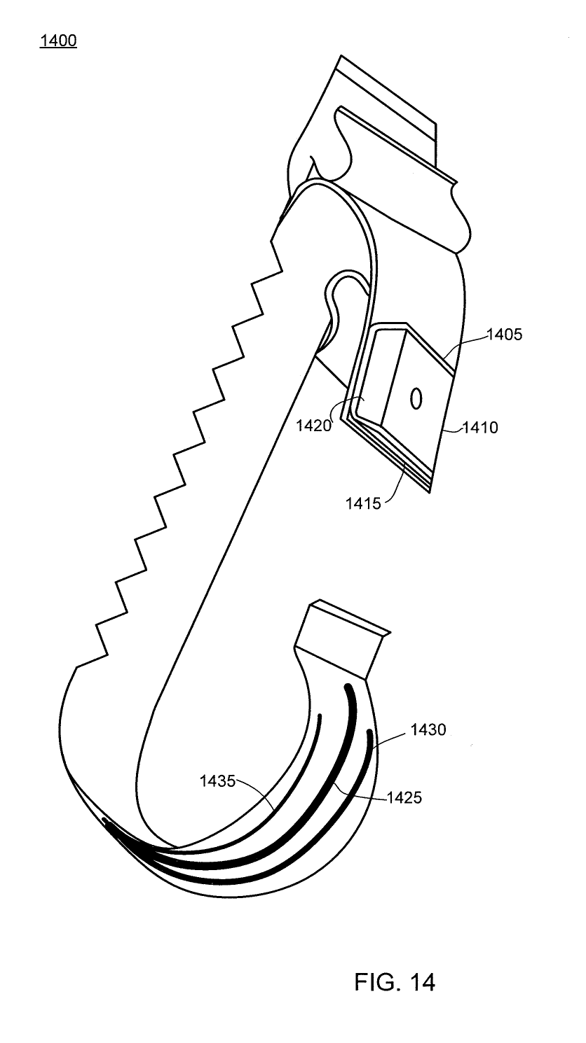

FIG. 14, a non-linear clip portion 125, a pressure handle portion 130, a roller cleaner 135 described in reference to FIGS. 12A-12C and FIGS. 14-15, a ladder clip/painter tape/rag holder portion 140 described in reference to FIGS. 7-9, a handle for small pails 145 described in reference to FIG. 5, a toothed portion or jagged side edge 150 described in reference to FIGS. 11A-11C, a small pail clip 155 and a 1-gallon paint can opener 160 described in reference to FIGS. 3A-3B.

The first step of a painting project often begins with preparing the surface to be painted. FIG. 2 depicts the scraper/putty knife of the exemplary multipurpose tool according to various embodiments. Specifically, FIG. 2A depicts the front view of multipurpose tool 100 showing scraper/putty knife 105, first semicircular hook 110, roller tray clip 115, magnetic assembly 120, roller cleaner 135, ladder clip/painter tape/rag holder portion 140, and toothed portion 150 according to one embodiment.

According to another embodiment, FIG. 2B depicts the right side view of multipurpose tool 100 illustrating scraper/putty knife 105, first semicircular hook 110, magnetic assembly 120 and non-linear clip portion 125.

According to yet another embodiment, FIG. 2C depicts the back view of multipurpose tool 100 illustrating scraper/putty knife 105 and toothed portion jagged side edge 150.

Additionally, according to another embodiment, FIG. 2D depicts the right side view of multipurpose tool 100 illustrating first semicircular hook 110, magnetic assembly 120 and non-linear clip portion 125.

Further, in one embodiment, the scraper or putty knife is used for filling holes. In another embodiment, the scraper or putty knife is used for smoothing a rough spot. In yet another embodiment, the scraper or putty knife is used for removing paint flakes. In various embodiments, multi-purpose tool enable better handling of painting instruments, e.g., paint brush, paint tape, pail, roller, roller tray and the like.

FIG. 3 graphically illustrates multipurpose tool 100 being utilized to open a can of paint according to various embodiments. Specifically, FIG. 3A graphically illustrates multipurpose tool 100 being used as a can opener according to one embodiment. The next step of the project might entail opening a can. Multipurpose tool 100 is well suited for the task. As seen, multipurpose tool 100 lid 310 of the can of paint in order to pry the open the can of paint.

FIG. 3B graphically illustrates multipurpose tool 100 being attached to the can 305 according to another embodiment. In this embodiment, multipurpose device 100 is equipped with a built-in device 105 to pry open a metal can of paint 305. In another embodiment, multipurpose device 100 is used to open a can of varnish. Multipurpose device 100 works for both right and left handed individuals.

FIG. 4 graphically illustrates magnetic assembly 120 of multipurpose tool 100 being affixed to a paint brush according to one embodiment. Specifically, FIG. 4 shows multipurpose tool 100 being attached to paint brush 405 via a magnetic device, which is a component of magnetic assembly 120. Multi-purpose tool 100 is further attached to container 410 thereby holding paint brush 405 inside the container. Hence, brush 405 remains inside bucket 410 enabling the bristles to stay moist while keeping brush 405 out of the way.

Having opened a can, a next step may be to start applying the paint to the surface via a paint brush. Once that paint brush is inserted into the can or container of paint and loaded with paint, it may become difficult to handle. Quite often the brush is left dangling on top of the can, pail, touchup container or roller tray, or the brush is simply held, which only leads to accidents. Additionally, it is optimal to have the wet bristles stay moist. In various embodiments, this multi-purpose tool product clips to any size bucket or pail from 1-quart to 5-gallon buckets, 1 gallon paint and the like. In one embodiment, the multipurpose device has a strong magnet that sits inside, allowing wet brush 405 to sit inside the bucket or pail 410 while remaining ready-to-use and safely out of the way.

FIG. 5 graphically illustrates multipurpose tool 100 being used as a handle for pint/quart size pails according to one embodiment. Some projects such as varnishing, touch-up might only involve a smaller size pail. In one embodiment depicted in FIG. 5A, multipurpose tool 100 is attached to a pint size pail 505 to be used as a handle. In another embodiment shown in FIG. 5B, multipurpose tool 100 is attached to a quart size pail 510 to also be used as a handle.

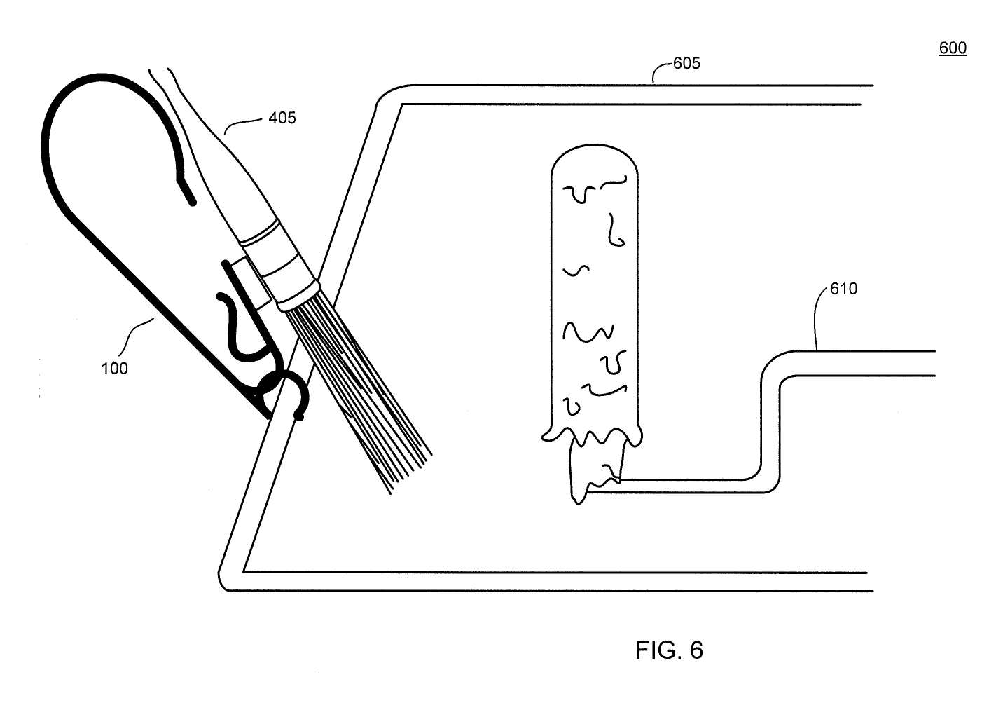

FIG. 6 graphically illustrates multipurpose tool 100 being attached to a roller tray according to one embodiment. Specifically, FIG. 6 shows multipurpose tool 100 being attached to paint brush 405 via magnet attachment 120. Paint brush 405 sits inside roller tray 605, which also houses roller 610. Frequently a painting project requires the utilization of a roller tray and roller in addition to the brush. In one embodiment, multipurpose tool 100 provides for attaching the tool to the roller tray while keeping paint brush 405 available when needed and still keeping those bristles moist. In other embodiments, paint brush 405 is kept soaking in cleaning agent or the like.

FIG. 7 graphically illustrates the multipurpose tool being used to drape one or more rags according to one embodiment. Specifically, FIG. 7 shows multipurpose tool 100 being attached to container 705 while second semicircular hook portion 140 of multipurpose tool 100 accommodates one or more rags. In one embodiment, multipurpose tool 100 acts as a hook allowing a user to drape one or more rags on the bottom of the hook. In another embodiment, magnet attachment 120 is adapted to be placed on any metal surface and utilized in various ways. For example, the arrangement may be used as storage in work vehicles or shop; to hang a lightweight coat, dust mask, gloves, goggle holder, and items on a refrigerator and so on.

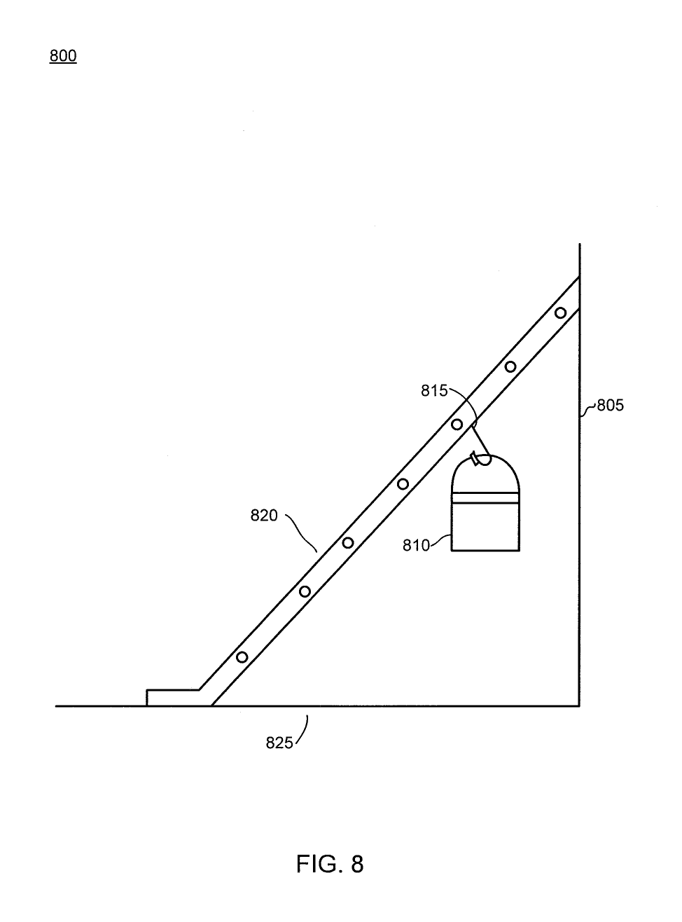

FIG. 8 graphically illustrates multipurpose tool 100 being used as a load bearing apparatus according to one embodiment. FIG. 8 shows extended ladder 820 extending from ground level 825 to wall 805. New wider multipurpose tool 815 is attached to ladder 815. Multipurpose tool 815 supports the load of bucket of paint 810.

In various circumstances, a user may need to climb an extension ladder while simultaneously holding a container of paint. This situation could prove difficult. In one embodiment, multipurpose tool 100 clips to any rung of the ladder while supporting the load of a paint bucket, brush or other tools.

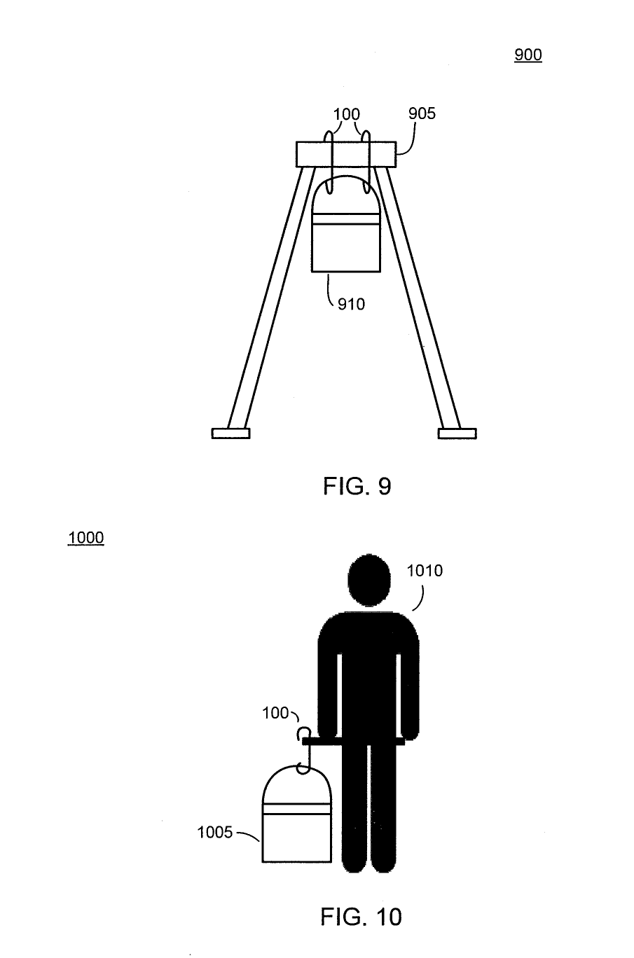

FIG. 9 graphically illustrates multipurpose tool 100 being used as a load bearing apparatus according to another embodiment. Specifically, FIG. 9 shows a step ladder 905 providing a hole to anchor multipurpose tool 100, which supports the load of container 910. In one embodiment, multipurpose tool 100 is used with a step ladder that does not provide a folding material support.

FIG. 10 graphically illustrates multipurpose tool 100 being used as a load bearing belt attachment according to one embodiment. Specifically, FIG. 10 shows user 1010 with multipurpose tool 100 attached to her/his belt supporting the load of container 1005. In one embodiment, user 1010 is working on the ground. In another embodiment, user 1010 is working on a ladder. In either case, multipurpose tool 100 clips to the belt holding needed items. In one embodiment, multipurpose tool 100 acting as a belt clip is adapted to carry a number of rolls of tape. In another embodiment, again multipurpose tool 100 acting as a belt clip is adapted to carry a bucket of paint. In various embodiments, other items are carried by multipurpose tool 100 acting as a belt clip.

FIG. 11 graphically illustrates the multipurpose tool being used to clean a paint brush according to one embodiment. Specifically, FIG. 11A shows toothed portion or jagged side edge 150 of multipurpose tool 100 gripping the wet bristles of paint brush 405 while liquid paint 1105 drips away from brush 405. FIG. 11B shows multipurpose tool 100 progressing toward the end of brush 405. FIG. 11C shows multipurpose tool 100 progressing further toward the end of brush 405.

Clean-up may be everyone's favorite part of any job. In one embodiment, multipurpose tool 100 assists in making this part of the job a lot easier. Toothed portion or jagged side edge 150 built into one side of the tool allows a user to clean almost any paintbrush completely and easily. Although depicted as cleaning brush 405, multipurpose tool 100 is adapted to be used for various other tasks.

FIG. 12 graphically illustrates the multipurpose tool being used to clean a roller according to one embodiment. Specifically, FIG. 12A shows second semicircular hook portion 140 of multipurpose tool 100 gripping roller 610. FIG. 12B shows multipurpose tool 100 progressing toward the end of roller 610. FIG. 12C shows multipurpose tool 100 progressing further toward the end of roller 610.

Cleaning of a roller has never been easier. In one embodiment, second circular portion 140 of multipurpose tool 100 is adapted to squeeze out the excess paint when placed over one end of a paint filled roller, allowing the user to put the roller directly back into its original container and making cleaning the roller a breeze. In another embodiment, pressure handle portion 130 is used to provide added pressure to thereby remove a greater volume of liquid.

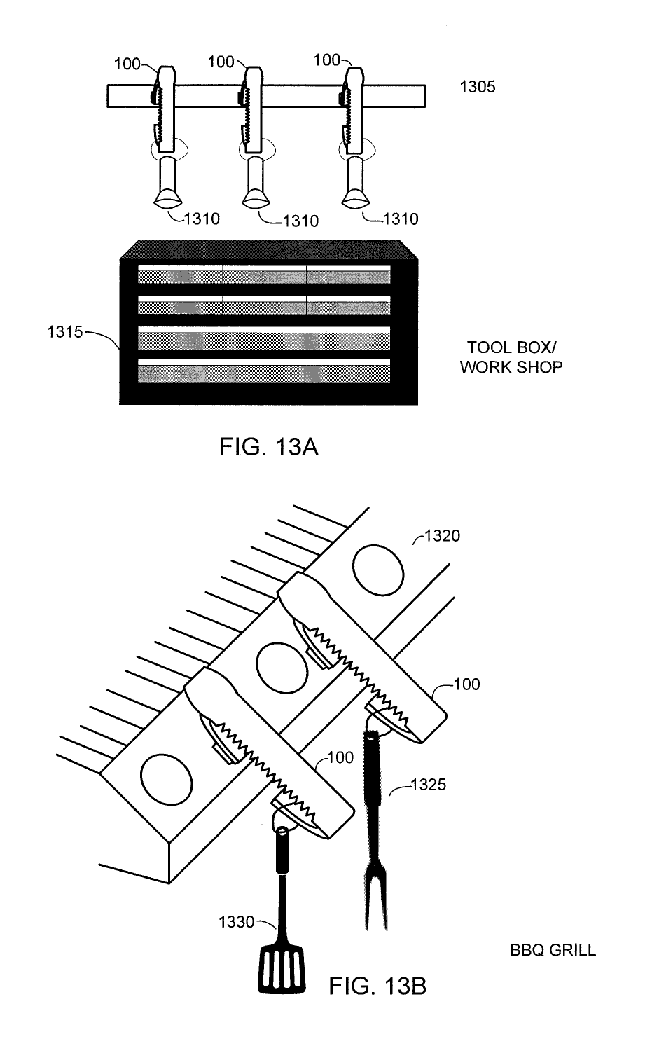

FIG. 13 graphically illustrates the multipurpose tool being used as an organizer according to one embodiment. Specifically, FIG. 13A shows second semicircular hook portion 140 of multipurpose tool 100 used to organize a particular area of an environment. Multi-purpose tool 100 attaches to object 1305 while second semicircular hook portion 140 holds object/instrument 1305. Multi-purpose tool 100 is easily stored.

In various embodiments, multipurpose tool 100 is used to accomplish a plurality of tasks. For example, with the super strong magnet, multipurpose tool 100 is adapted to attach to any metal surface providing a plethora of uses including barbecue grill accessory holder, work vehicle organization, refrigerator utilization, tool box/work shop organization.

FIG. 13B shows magnet portion 120 of multipurpose tool 100 attaching to a barbecue-grill 1320 while second semicircular hook portion 140 anchors fork 1325 and flatware 1330.

In various embodiments, multipurpose tool 100 is used to handle a full gallon can of paint. As a result, the tool may be adapted to decrease its flexibility or increase its rigidity.

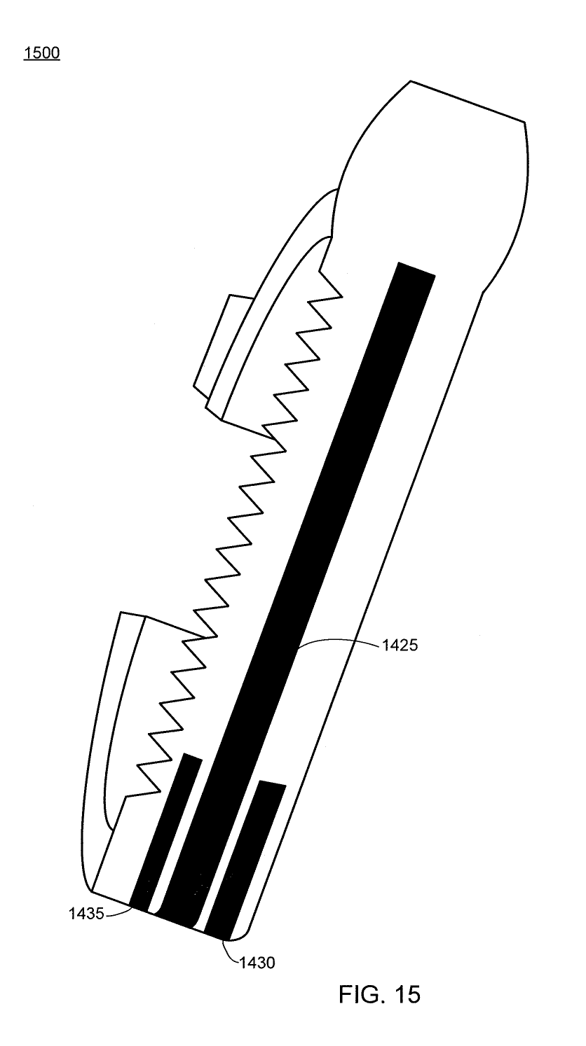

FIG. 14 depicts an exemplary embodiment of the multipurpose tool with a plurality of reinforcement splines (or ribs) and magnet cushions according to one embodiment. Specifically, roller cleaner 135 is outfitted with reinforcement splines/ribs 1425, 1430 and 1435, which are further described with respect to FIG. 15. Although primarily described with respect to an embodiment where three reinforcement splines or ribs are used, any number of reinforcement splines or ribs may be used.

Moreover, the ceramic magnet or magnetic device may break or shatter if the multipurpose tool is dropped. Accordingly, the magnet is cushioned to attenuate a mechanical shock resulting from contact with a landing surface in the event that the multipurpose tool is dropped.

Magnetic assembly 120 is shown with top cushion 1405, right side cushion 1410, bottom cushion 1415 and left side cushion 1420. In various embodiments, magnetic assembly 120 comprises tracks or gaps on lower portion of inner area of top cushion 1405 and bottom cushion 1415 thereby forming a channel allowing the magnet device to be securely adhered to the magnetic assembly. Although primarily described with respect to an embodiment where top cushion 1405 and bottom cushion 1415 are used, any other arrangement may be used.

In one embodiment, magnetic assembly 120 comprises a protrusion.

Although primarily described with respect an embodiment where four cushions are used, any suitable number of cushions may be used.

FIG. 15 depicts an exemplary embodiment of the multipurpose tool showing the length of the plurality of reinforcement splines (or ribs) according to one embodiment. The reinforcement splines/ribs are primarily used as a variable strength adjustment arrangement as described above. As such, the number, distance between reinforcement splines 1425, 1430 and 1435, the width of the reinforcement spines 1425, 1430 and 1435, the length of the reinforcement splines 1425, 1430 and 1435 and any combination thereof may be adapted to comply with the requirements of a specific situation or environment.

1. A multipurpose tool, comprising:
a flexible material comprising a proximate region formed as a scraper and a first semicircular hook, a distal region formed as a second semicircular hook, and a straight intermediate region therebetween having a jagged side edge or toothed portion;
wherein said first semicircular hook comprises an inner surface with a clip formed thereon.

2. The multipurpose tool of claim 1, wherein said first semicircular hook further comprises an outer surface adapted to receive a magnetic assembly.

3. The multipurpose tool of claim 2, wherein said outer surface of said first semicircular hook further comprises one or more protective cushions having a height greater than said magnetic assembly.

4. The multipurpose tool of claim 2, wherein said magnetic assembly comprises a magnet secured to a metal holder.

5. The multipurpose tool of claim 1, wherein said outer surface of said first semicircular hook further comprises a second clip aligned with said scraper.

6. The multipurpose tool of claim 1, wherein said clip is adapted to receive a wire paint can handle for lifting a paint can thereby.

7. The multipurpose tool of claim 2, wherein said clip is adapted to receive an edge of a paint can to thereby position said magnetic assembly within said paint can, said magnetic assembly being adapted to magnetically secure a paint brush within said paint can.

8. The multipurpose tool of claim 1, wherein said second semicircular hook is adapted to receive a ladder step for hanging said multipurpose tool therefrom.

9. The multipurpose tool of claim 1, wherein said first semicircular hook is defined by a first radius and said second semicircular hook is defined by a second radius, said first radius being smaller than said second radius.

10. The multipurpose tool of claim 1, wherein said first and second semicircular hooks include respective inner portions facing said intermediate region.

11. The multipurpose tool of claim 1, wherein said second semicircular hook includes an outer portion having disposed thereon a reinforcement spline.

12. The multipurpose tool of claim 1, wherein said second semicircular hook includes an outer portion having disposed thereon a plurality of reinforcement spines.

13. The multipurpose tool of claim 12, wherein said plurality of reinforcement splines comprise splines of at least two different lengths.

14. The multipurpose tool of claim 1, wherein the second semicircular hook anchors to a plurality of areas to thereby provide a load bearing function.

15. The multipurpose tool of claim 1, wherein the second semicircular hook is used to clean excess paint off a roller.

16. The multipurpose tool of claim 8, wherein the second semicircular hook is terminated by a flange.

17. The multipurpose tool of claim 16, wherein the flange is disposed at an acute angle with respect to the second semicircular hook.

18. The multipurpose tool of claim 1, wherein the multipurpose tool comprises one or more reinforcement splines placed on the outside contour of the multipurpose tool, the one or more reinforcement splines being of variable length and variable separation distance.

19. The multipurpose tool of claim 1, wherein the multipurpose tool comprises one or more reinforcement splines placed on the outside contour of the multipurpose tool, the one or more reinforcement splines being of equal length and equal separation distance.

20. The multipurpose tool of claim 5, wherein the magnet portion comprises a plastic protrusion and one or more cushions located on top and bottom of the magnet.
